(19) United States
(12) Patent Application Publication
(10) Pub. No.: US 2006/0292345 A1
(43) Pub. Date: Dec. 28, 2006

(54) Micropatterned superhydrophobic silica based sol-gel surfaces

(76) Inventors: Bakul C. Dave, Carbondale, IL (US); Murti S. Rao, Mundelein, IL (US)

Correspondence Address: THOMPSON COBURN, LLP, ONE US BANK PLAZA, SUITE 3500, ST LOUIS, MO, 63101, US

(21) Appl. No.: 11/453,547

(22) Filed: Jun. 14, 2006

Related U.S. Application Data
(60) Provisional application No. 60/690,405, filed on Jun. 14, 2005.

(51) Int. Cl. G11B 5/64

(52) U.S. Cl. 428/141

(57) ABSTRACT

A surface that is at least hydrophobic that is formed from a mixture that comprises a sol-gel that comprises an alkoxosilane precursor having a general formula of R′ₓSi(OR)₄₋ₓ or (RO)₃SiR″Si(OR)₃, wherein R and R′ are the same or different and comprise hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2. Also, the surface has a topography that decreases a contact area between the surface and a water droplet thereon.

### BACKGROUND OF THE INVENTION

1. Field of the Invention

The present invention is directed to hydrophobic coatings and, more particularly, hydrophobic coatings formed with organosilane sol-gels.

2. Description of the Related Art

The phenomenon of superhydrophobicity, inspired from the “lotus leaf effect,” has led to the technological development of superhydrophobic materials and coatings, which consist of a hydrophobic, rough surface with low surface energy. The lotus leaf effect is revealed from a study of the surfaces of lotus leaves. The surface of a lotus leaf is covered with countless miniature protrusions coated with a waxy layer. This waxy layer acts as a multifunctional interface between the leaf and its environment, influencing the airflow and light reflection, and imparting very high water repellency to the leaf to cause water to roll over its surface as small droplets. These hydrophobic microscopic topographical features minimize the area of contact of water with the leaf surface, thereby keeping the water in contact mainly with air. Hence the water on the leaf surface substantially retains the droplet shape it would have in air. One of the methods of measuring the water repellency of a surface is to measure contact angle of a water drop with the surface. Higher contact angles imply an enhanced hydrophobic surface and greater water repellency. Smooth hydrophobic surfaces tend to have contact angles up to 110°, but the rough microstructures present on the lotus leaf result in contact angles as high as 170°, thereby imparting to the surface enhanced superhydrophobic properties.

Since much of the superior water-repellency of the lotus leaf derives from the structural (microscopic features) and chemical (waxy) properties, extensive research has been carried out to develop techniques to create such microscopic features and wax-like properties on artificial surfaces. For example, the development of superhydrophobic materials and surfaces have been investigated for practical and technical applications such as water repelling and self-cleaning coatings for fabrics and textiles; coatings that impart wrinkle resistance to fabric; self-cleaning coatings for ovens, electric ranges, filters, and window blinds; anti-soiling coatings for titanium surfaces, transparent substrates, painted surfaces, wall-papers, and washing-machine tubs; water-repellant and self-cleaning coatings for automobile glass, optics, laser glass, exterior walls of buildings, paints; anti-corrosion coatings; and coatings for biomedical applications. Typically, artificial hydrophobic surfaces must have contact angles greater than 150° to acquire the “super” prefix.

Over the years, a variety of approaches have been followed in order to create a hydrophobic surface with microrough features to impart superhydrophobic properties to the surface. Hydrophobic materials developed thus far are based on polymeric systems such as poly(phytanyl methacrylate), a copolymer of 2-isopropenyl-2oxazoline and methyl methacrylate, other acrylic-siloxane based systems, silica and aluminum based polymer systems, a hybrid hydrophobic material comprising electro-deposited nickel and organofluoro polymeric components on a glass substrate, and polymers comprising one or more fluoro groups. The microroughness on the surface of coatings comprising the foregoing hydrophobic materials was created by employing techniques such as dispersing particles made of TiO₂ in a hydrophobic polymer for photocatalytic assistance in formation of self-cleaning surfaces, dispersing polymeric and metallic particles, chemical micropatterning, self-assembly, photolithography, capillary force lithography, and soft lithography. Of these techniques, the soft lithographic technique is generally considered by those skilled in the art be the most convenient process because it is carried out under ambient conditions. The category of soft lithography comprises various techniques such as self-assembly, micro-contact printing, and embossing. In fact, embossing has been widely used to develop patterns on glass, metallic, or Si (110) surfaces. Typically, embossing is accomplished by contacting a partially hydrolyzed viscous polymer with a stamp having pattern on the surface to imprint the pattern in the polymer. Typically, the surface of the stamp/mold contacting the sol-gel is PDMS, which generally does not chemically interact with the sol-gel.

Despite the foregoing efforts to create artificial superhydrophobic surface coatings, a need still exists for a hydrophobic and superhydrophobic coatings that have one or more of the following properties: may be applied or formed at low temperatures using relatively simple synthesis and working procedures; relatively free of undesirable impurities; controlled structures and compositions at the molecular level; the ability to tailor textural properties such as surface area and pore size distribution; optical transparency at thicknesses greater than about 300 nm; the ability to include multiple constituents in a single application that has a high degree of homogeneity; and may be prepared in different physical forms such as monolith, thin film, and particulate.

### BRIEF SUMMARY OF THE INVENTION

The present invention is directed to a composite having a surface that is at least hydrophobic, the composite a substrate, and a hydrophobic coating on at least a portion of the substrate, the hydrophobic coating being formed from a mixture comprising a sol-gel that comprises an alkoxosilane precursor having a general formula of R′xSi(OR)₄₋ₓ or (RO)₃SiR″Si(OR)₃, wherein R and R′ are the same or different and are hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2, and comprising a topography that decreases a contact area between the hydrophobic coating and a water droplet thereon.

Additionally, the present invention is directed to a composite having a surface that is at least hydrophobic, wherein the composite comprises a substrate and a hydrophobic coating on at least a portion of the substrate. The hydrophobic coating is formed from a mixture comprising a sol-gel that comprises an alkoxosilane precursor having a general formula of R′₂Si(OR)₂, R′₃Si(OR)₃, or (RO)₃SiR″Si(OR)₃, wherein R is a short chain, branched or unbranched, organic group that comprises no more than 5 carbon atoms in the chain and are the same or different, and R′ and R″ are long chain, branched or unbranched, organic groups that comprise between 6 and 20 carbon atoms in the chain, and comprises a topography that decreases a contact area between the hydrophobic coating and a water droplet thereon.

The present invention is also directed to a superhydrophobic surface. The superhydrophobic surface is formed from a mixture comprising a sol-gel that comprises an alkoxosilane precursor having a general formula of R′xSi(OR)₄₋ₓ or (RO)₃SiR″Si(OR)₃, wherein R and R′ are the same or different and comprise hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2. The superhydrophobic surface also comprises a topography that decreases a contact area between the superhydrophobic surface and a water droplet thereon so that the water droplet has a contact angle of at least about 160°.

Still further, the present invention is directed to a method of forming a composite having a surface that is at least hydrophobic. The method comprising depositing a hydrophobic coating on at least a portion of a substrate. The hydrophobic coating being formed from a mixture comprising a sol-gel that comprises an alkoxosilane precursor having a general formula of R′xSi(OR)₄₋ₓ or (RO)₃SiR″Si(OR)₃, wherein R and R′ are the same or different and comprise hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2. Also, the hydrophobic coating comprises a topography that decreases a contact area between the hydrophobic coating and a water droplet thereon.

### BRIEF DESCRIPTION OF THE DRAWINGS

FIG. 1 contains A) an optical image and B) a SEM image of an organic template having an average feature size of about 60 micrometers.

FIG. 2 contains optical images of templates having an average feature size of about 6 micrometers or about 11 micrometers, and Bis-[3-(trimethoxysilyl)-propyl]-ethylenediamine (enTMOS) and ethyltrimethoxysilane (ETMOS) coatings patterned with those templates.

FIG. 3 contains optical images of templates having an average feature size of about 15 micrometers or about 33 micrometers, and enTMOS and ETMOS coatings patterned with those templates.

FIG. 4 contains optical images of templates having an average feature size of about 40 micrometers or about 60 micrometers, and enTMOS and ETMOS coatings patterned with those templates.

FIG. 5 contains optical images of templates having an average feature size of about 80 micrometers or about 100 micrometers, and enTMOS and ETMOS coatings patterned with those templates.

FIG. 6 contains optical and SEM images of enTMOS base layer-ETMOS top layer coatings patterned with templates having an average feature size of about 40 or about 200 micrometers.

FIG. 7 contains graphs of the contact angle as a function of template feature size for differing hydrophobic coating compositions.

FIG. 8 is a graph of contact angle versus ratio of sol-gel constituents for hydrophobic coatings.

FIG. 9 is a graph of the contact angle versus pore size of template for two hydrophobic coating compositions.

FIG. 10 contains SEM images of a patterned at coating at magnifications of A) 120 times and B) 300 times.

FIG. 11 is a graph comparing the water repellency of fabric treated with a conventional treatment and fabric treated according to the present invention.

### DETAILED DESCRIPTION OF THE INVENTION

According to the present invention, it has been discovered that hydrophobic coatings prepared by the sol-gel method using one or more organically-modified alkoxosilane precursors can be applied to a wide variety of materials, including metals, ceramics, polymers, and fabrics. Indeed, it is believed that such hydrophobic coatings may be applied according to one or more methods of the present invention to a surface of essentially any article made from essentially any material.

In one embodiment of the present invention, the hydrophobic coating is transparent and the surface of the coating is relatively smooth. In another embodiment of the present invention, the hydrophobic coating comprises a surface relief, texture, roughness, or microscopic topographical features that significantly reduce the contact area between water and the surface, thereby keeping water mainly in contact with air. State another way, for two coatings that are identical except that one comprises the above-described topography and the other does not are tested for water repellency under identical conditions, the contact area between a water droplet on the coating with the topography will be less or decreased compared to the contact area between a water droplet on the coating without the topography. Thus, the topography decreases the contact area between the hydrophobic coating and a water droplet thereon.

In summary, the hydrophobic coating compositions when deposited on a substrate forms a composite having increased water repellency or hydrophobicity compared to the substrate. Further, the hydrophobic coating compositions of the present invention, the methods of the present invention, and the substrate may be selected singularly or in combination to produce a composite having a surface that is at least hydrophobic (e.g., a contact angle between the coating and water thereon of at least about 80°, preferably at least about 90°, more preferably at least about 100°, and still more preferably at least about 110°, 120°, 130°, 140°, or greater). In certain embodiments, the hydrophobic coating compositions and methods of the present invention, and substrate may be selected singularly or in combination to produce a composite having a surface that is at least superhydrophobic (e.g., a contact angle between the coating and water thereon of at least about 150°, preferably at least about 160°, more preferably at least about 165°, and still more preferably at least about 170°). In addition to increasing the hydrophobicity of a substrate material, a coating of the present invention may impart the property of self-cleaning.

The sol-gel process is a low temperature solution-based method for making silica glasses. In the sol-gel process, a suitable alkoxy precursor or combination of precursors is hydrolyzed to generate a solid state polymeric oxide network. The initial hydrolysis of the precursor(s) generates a liquid sol that ultimately becomes a porous gel. The present invention is directed to coatings that are formed from at least one alkoxosilane precursor that is modified with at least one organic group (i.e., at least one of the alkoxy groups is replaced by an organic group), which results in a hybrid inorganic-organic sol-gel precursor or organic-inorganic siloxane that is used to form an organically modified silicate glass. Because the sol-gel procedure forms a glass from a solution using a molecular precursor, the sol-gel may be designed at the molecular level by an appropriate selection of the modifying organic functional group(s), which allows for considerable control over the properties (e.g., porosity and hydrophobicity) of the coating.

Specifically, the organically-modified alkoxosilane precursors that form the hydrophobic coatings of the present invention are organically modified silicate (ORMOSIL) monomers having a general formula of (R′)ₓSi(OR)₄₋ₓ, wherein x is 1 or 2; and a silsequioxane-type or alkoxodisilane monomers having a general formula of (RO)₃SiR″Si(OR)₃; or a combination thereof. In the foregoing formulas, R and R′ may be hydrogen or an organic group and may be the same or different, and R″ may be a divalent organic group. More specifically, R and R′ may be the same or different and may be hydrogen, an alkyl, an alkenyl, an alkynyl, an aryl group, or combinations thereof as defined herein below. Similarly, R″ may be an alkylene, an alkenylene, an alkynylene, an arylene group, or combinations thereof as defined hereinafter.

Within the definitions of R and R′ in the general formulas referenced above, the term “alkyl” is meant to have its art-recognized meaning. Substituted and unsubstituted, as well as branched and unbranched C₁ through C₂₀-alkyls are particularly contemplated, including methyl-, ethyl-, propyl-, isopropyl-, n-propyl- and butyl-. Exemplary substituents include —OH and —OR′″, wherein R′″ is a C₁₋₄ alkyl. Table A, below, also sets forth contemplated alkyls. Similarly, with respect to R″, the term “alkylene” is meant to have its art-recognized meaning. Substituted and unsubstituted, as well as branched and unbranched C₁ through C₂₀-alkylenes are particularly contemplated. Table A, below, also sets forth contemplated alkylenes.

Regarding the meaning of the term “substituted,” one or more of the R, R′, and R″ groups may comprise one or more functional groups, which may be a part of the backbone, part of a pendant group, or both, such as those having a moiety or comprising —S, —N, —N═N—, a halogen (e.g., —I, —Br, —F, and —Cl), —OR, —R—O—R, —HOOCR, and —HOR (where R=hydrogen, alkyl, alkenyl, alkynyl, or aryl as defined herein below, and R may be the same moiety or different moieties).

Within the definitions of R and R′ in the general formulas referenced above, the term “alkenyl” is meant to have its art-recognized meaning. Substituted and unsubstituted, as well as branched and unbranched C₁ through C₂₀-alkenyls having at least one double bond at varying location(s) are particularly contemplated, including vinyl-, allyl- and isopropenyl-. Exemplary substituents include —OH and —OR′″, wherein R′″ is a C₁₋₄ alkyl. Table A set forth below also sets forth contemplated alkenyls. Likewise, with respect to R″, the term “alkenylene” is meant to have its art-recognized meaning. Substituted and unsubstituted, as well as branched and unbranched C₁ through C₂₀-alkenylenes are particularly contemplated.

Within the definitions of R and R′ in the general formula referenced above, the term “alkynyl” is meant to have its art-recognized meaning. Substituted and unsubstituted, as well as branched and unbranched C₁ through C₂₀-alkynyls having at least one triple bond at varying locations are particularly contemplated, including ethynyl-, propynyl-, and butynyl-. Exemplary substituents include —OH and —OR′″, wherein R′″ is a C₁₋₄ alkyl. Table A set forth below also sets forth contemplated alkynyls. Similarly, with respect to R″, the term “alkynylene” is meant to have its art-recognized meaning. Substituted and unsubstituted, as well as branched and unbranched C₁ through C₂₀-alkynylenes are particularly contemplated.

Within the definitions of R and R′ in the general formula referenced above, the term “aryl” is meant to have its art-recognized meaning. Substituted, unsubstituted, and multiple ring aryl groups are particularly contemplated, including benzyl-, ethylbenzyl-, phenyl-, xylene substituents, toluene substituents, sytrene substituents, and naphthalene substituents. Table A set forth below also sets forth contemplated aryls. Moreover, with respect to R″, the term “arylene” is meant to have its art-recognized meaning. Substituted and unsubstituted, and multiple ring arylene groups are particularly contemplated.

TABLE A

| | | | |
|---|---|---|---|
| n-(CH₂)₂CH₃ | n-(CH₂)₃CH₃ | CH(CH₃)₂ | CH₂CH(CH₃)₂ |
| CH(CH₃)CH₂CH₃ | n-O(CH₂)₂CH₃ | n-O(CH₂)₃CH₃ | OCH(CH₃)₂ |
| OCH(CH₃)₂ | OCH₂CH(CH₃)₂ | OCH(CH₃)CH₂CH₃ | OPh* (*Ph — |
| | | | phenyl) |
| OCH₂CH₂OH | OCH₂CH₂OCH₃ | n-CH₂(CH₂)₄₋₁₆CH₃ | OCH₃ |
| CH₂CH₃ | CH₃ | (CH₂)₃NH(CH₂)₂NH(CH₂)₃ | (CH₂)₃NH(CH₂)₃ |
| (CH₂)₃NHCONH(CH₂)₃ | OC₆H₄N═NC₆H₄O | | |

The sol-gel process may be considered as comprising the following stages or steps: forming a sol, gelation (i.e., polymerization), aging, and drying. Of particular interest is the gelation or polymerization stage, and it may, without being held to a particular theory, be described as two-step reaction comprising hydrolysis of an organically modified silicate precursor followed by condensation of the hydrolyzed precursor. The initiation of the polymerization reaction is typically performed via hydrolysis of alkoxide groups to form hydroxylated Si—OH groups. An example of this hydrolysis is set forth in the following equation:
(R′)ₓSi(OR)₄₋ₓ+H₂O→[R′Si(OR)₄₋ₓ₋₁OH]+ROH (1).
Propagation then occurs by the polycondensation of these hydroxylated species giving rise to oxypolymers. The polycondensation involves an oxylation reaction that, in turn, leads to the formation of oxo bridges and the removal of XOH species as indicated in the following equation:
—SiOH+SiOX→—SiOSi—+XOH(X=H or R) (2).
As the hydrolysis and condensation reactions continue, the viscosity increases and the solution eventually ceases to flow. The transition of sol to gel is irreversible and there is little to no change in the volume. At this stage in the process, the single-phase liquid has become a two-phase gel comprising a —SiOSi— network (solid phase) with an interstitial liquid phase. After reaching the gel state, the sol-gel may be allowed to age for a period of time that may be as short as a few hours and as long as a few days to allow the condensation reactions to continue thereby increasing the degree of cross linking in the network, which tends to increase mechanical strength and rigidity of the coating. If performed, the aging of the sol-gel typically is done in a sealed container to minimize or reduce solvent loss or shrinkage. Whether aged or not, the sol-gel coating is usually dried to remove solvent from the pores, which typically results in considerable shrinkage (e.g., most shrinkage studies on bulk gels report decrease in volume that is between about 20 and about 60%).

The chemistry of silica-based sol-gel systems and the manner that the reaction parameters influence the microstructural development of the gel are well understood by those skilled in the art. For example, several parameters known to influence the hydrolysis and condensation reactions include temperature, solution pH, alkoxide precursor composition, the solvent, and relative concentrations of each sol-gel constituent. According to the present invention, covalent modification of the alkoxy silane(s) at the molecular level (e.g., by replacing one or more alkoxy groups with hydrogen, an organic group, other functional group, or a combination thereof) modifies properties such as hydrophobicity/hydrophillicity, porosity, surface structure, bonding strength to a substrate, etc.

As mentioned above the selection of the modifying organic functional groups (e.g., R, R′, and R″) affects coating properties such as hydrophobicity/hydrophillicity, porosity, surface structure, and substrate bonding strength. In accordance with the present invention, the selection of the precursor or a combination of precursors is preferably based, at least in part, on the desired degree of hydrophobicity. In general, it is desirable to maximize the hydrophobicity of the coating by selecting a precursor that forms a coating layer with the highest degree of intrinsic hydrophobicity. It is important to note, however, that other properties such porosity and adhesion may, in some instances, necessitate the selection of a precursor or precursors with a lesser degree of hydrophobicity. In other words, the selection of a precursor or combination of precursors may be based on various factors including the ultimate end use, ease of application, and cost.

More specifically, the degree of hydrophobicity, porosity, adhesion, etc. are primarily affected by the selection of the R′ group or the R″ group. Although R′ may be a hydrogen, it is generally not preferred because such a sol is typically not sufficiently stable. Instead, it generally preferred that the R′ group or R″ group be an organic group (substituted or unsubstituted) that comprises between about 1 and about 20 carbon atoms. Also, it is preferred that the R′ group be a substituted or unsubstituted alkyl and the R″ group be a substituted or unsubstituted alkylene. In view of the foregoing, the R′ group is preferably a substituted or unsubstituted C₁₋₂₀-alkyl (e.g., methyl-, ethyl-, propyl-, isopropyl-, n-propyl-, butyl-, etc.) and the R″ group is preferably a substituted or substituted C₁₋₂₀-alkylene.

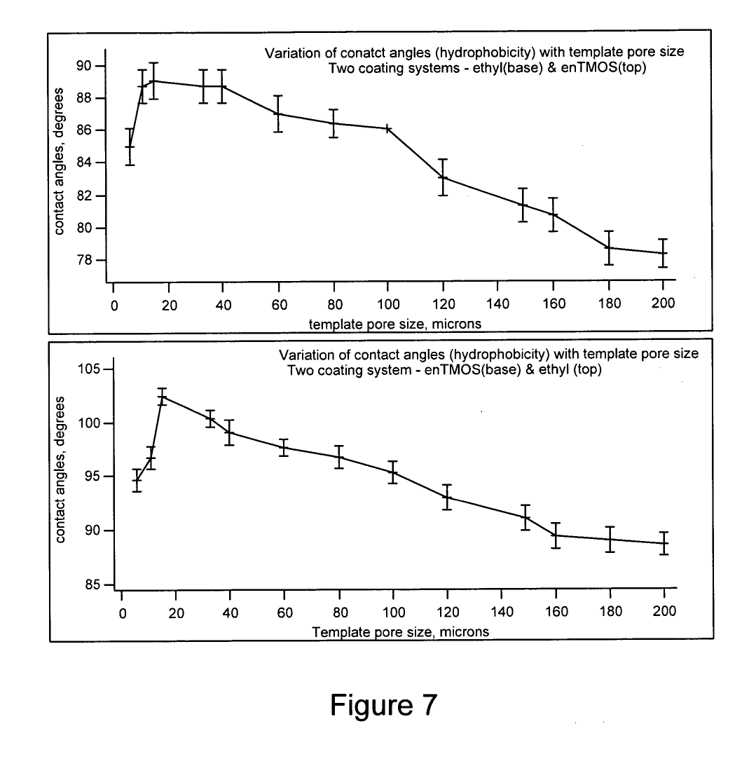

Additionally, because the degree of hydrophobicity tends to increase with the number of carbon atoms in the R′ or R″ group, it is generally preferred that the R′ or R″ group comprise at least about six carbon atoms. For example, it has been observed that a coating comprising an outer layer formed from a n-butyltrimethoxy silane precursor, having the formula of (CH₃O)₃Si(CH₂)₃CH₃, tends to have a greater hydrophobicity than a similarly prepared coating comprising an outer layer formed from an ethyltrimethoxysilane precursor, having the formula (CH₃O)₃SiCH₂CH₃ (see FIG. 7).

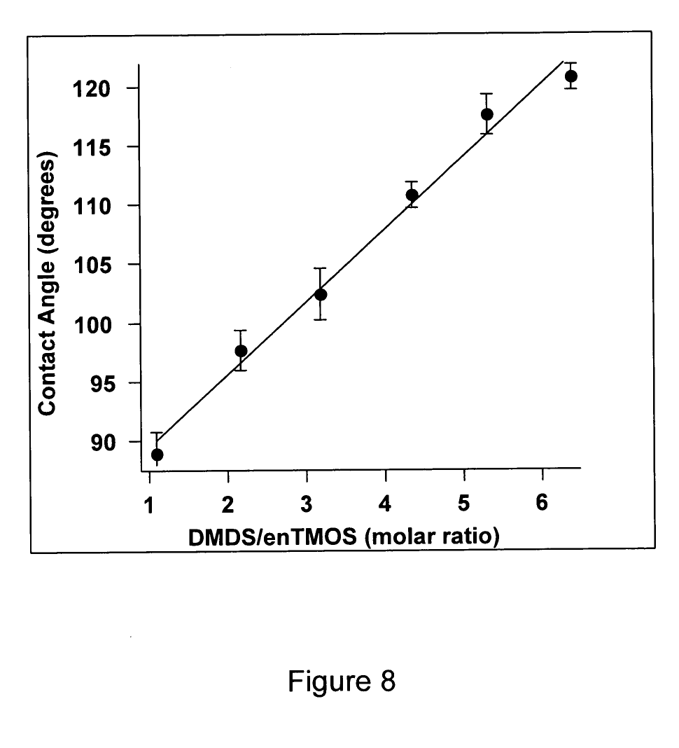

Also, it has been discovered that the make-up or components of the R′ or R″ group may also affect the hydrophobicity of coating. Specifically, it has been observed that monovalent alkyl groups tend to increase the hydrophobicity of a coating more than divalent alkylene groups. For example, when testing coatings formed from a combination of Bis-[3-(trimethoxysilyl)-propyl]-ethylenediamine (enTMOS) precursor, having the formula of (CH₃O)₃Si(CH₂)₃NH(CH₂)₂NH(CH₂)₃Si(OCH₃)₃, and dimethyldimethoxy silane (DMDS) precursor, having the formula (CH₃0)₂Si(CH₃)₂, at different ratios, it was discovered that the hydrophobicity increased with the amount of DMDS precursor (see FIG. 8). This despite the fact that the R″ group of the enTMOS precursor comprises eight methylene groups and was longer than the R′ groups of the DMDS precursor, each of which only comprised a single methyl group. Without being held to a particular theory, it is believed that increasing the relative amount of DMDS increased the hydrophobicity because methyl groups have a lower surface energy than methylene groups. In view of this, in an embodiment of the present invention in which the sol-gel comprises a mixture of enTMOS and DMDS, the molar ratio of enTMOS to DMDS is preferably between about 1:0.64 and about 1:10, and more preferably between about 1:1 and about 1:6.

As mentioned above, the porosity of the sol-gel may also be a consideration when selecting a precursor or precursors. For example, it is generally desirable for a coating on clothing to be sufficiently porous so as to allow the transport of moisture vapor evolved from perspiration. Controlling porosity may also be desirable for applications in which the sol-gel coating is being used as a filter. As with hydrophobicity, the porosity may be tailored by selecting the R′ or R″ group of the precursor to control the interaction between the generally hydrophilic silicate groups and the generally hydrophobic organic R′ or R″ groups. In general, as the hydrophobic R′ or R″ group's length is increased, the pores tend to be smaller. This is because the generally hydrophobic R′ or R″ groups tend to minimize their free energy by aggregating in the pores. Specifically, the R′ or R″ group tends to be repelled by the hydrophilic Si—O—Si groups and the best manner to do this is to locate at least a portion of itself in a pore. Thus, as the length or size of the R′ or R″ group is increased, more of the available pore volume is filled and the gel tends to be less porous. In view of this, it is generally preferred that the carbon chain of the R′ or R″ group comprise no more than about 18 carbon atoms.

In view of the competing nature of hydrophobicity and porosity, it is generally preferred that the carbon chain of the R′ or R″ group comprise between about 6 and about 18 carbon atoms. More preferably, the R′ is C₆₋₁₈-alkyl and the R″ group is a C₆₋₁₈-alkylene, which, are for purposes of this invention, considered to be relatively long chain organic groups. In contrast, it is generally preferred that the R groups be short chain organic groups. Specifically, the R groups preferably comprise no more than about 5 carbon atoms. More preferably, the R groups comprise no more than about 2 carbon atoms (e.g., a —CH₃ group or a —C₂H₅ group).

As set forth above, the R, R′, and R″ groups may be substituted. In fact, it may be desirable for the R′ or R″ group to comprise one or more such substitutions. For example, it has been discovered that the inclusion of a fluoro- or a cyano-group tends to increase the adhesion between a substrate (e.g., ceramic, glass, metal, and polymer) and a sol-gel in contact therewith. The inclusion of fluoro- or cyano-groups, however, is generally not preferred for coatings that are subjected to a high degree of skin contact. Additionally, the avoidance of certain functional groups such as fluoro- and cyano-groups may be desirable because of the environmental or safety concerns. The sol-gel precursors with an R group that comprises fluoro- or cyano-functional groups that were actually tested are cyanoethyltriethoxysilane and tridecafluoro-(1,1,2,2-tetrahydrooctyl)triethoxysilane (TFT). Nevertheless essentially any sol-gel precursor with an R group that comprises fluoro- or cyano-functional groups may be used. Cyano-containing examples include bis(cyanopropyl)dichlorosilane, bis(3-cyanopropyl)dimethoxysilane, 2-cyanoethylmethyldichlorosilane, 2-cyanoethyltrichlorosilane, 2-cyanoethyltrimethoxysilane, 3-cyanopropylmethyldimethoxysilane, 3-cyanopropyltrimethoxysilane, 3-cyanopropyltriethoxysilane, 11-cyanoundecyltrimethoxysilane, poly(cyanopropylmethylsiloxane), etc. Fluoro-containing examples include poly(3,3,3-trifluoropropylmethylsiloxane), (heptadecafluoro-1,1,2,2-tetrahydrodecyl)trichlorosilane, (heptadecafluoro-1,1,2,2-tetrahydrodecyl)methyidichlorosilane, (heptadecafluoro-1,1,2,2-tetrahydrodecyl)triethoxysilane, (heptadecafluoro-1,1,2,2-tetrahydrodecyl)trimethoxysilane, pentafluorophenyltriethoxysilane, 3,3,3-trifluoropropyl)trimethoxylsilane, etc. In summary, essentially any silane comprising cyano or flouro groups may be used.

A further functional group that may be desirable is the amine group. The inclusion of an amine group may be of benefit, for example, in the applications related to fabrics because amino functional groups tend to bind to fabric surfaces well. Also, including amino groups may be desirable because they tend to soften fabrics, which may, at least partially, counter the stiffening effect typically associated with the hydrophobic groups. For metallic and purely organic polymer (e.g., polyethylene or polypropylene) surfaces, amino groups may be included to enhance the bonding interactions. But for application in which self-cleaning is desired, amine functional groups would generally not be preferred because including amino groups typically reduces the contact angle. Examples of preferred sol-gel precursors with an R group that comprises an amine group include 3-aminopropyl trimethoxysilane, N-(2-aminoethyl) 3-aminopropyl trimethoxysilane, (3-trimethoxysilylpropyl) diethylenetriamine, and Bis-[(trimethoxysilyl)-propyl]-ethylenediamine. Nevertheless, essentially any amine-containing silane or polymer may be used.

Processes for forming sol-gels and modified alkoxysilane precursors are known to those skilled in the art and may be used to form the precursors of the present invention as set forth below. Likewise, known processes for applying, forming, or depositing a sol-gel coating on a substrate (e.g., dipping, spraying, or painting on with a brush) or for forming sol-gel monoliths (e.g., casting) are equally applicable to the precursors of the present invention. Additionally, as set forth in greater detail below, the hydrophobic sol-gel coatings of the present invention may be formed by a single application of an alkoxysilane precursor or a combination or multiplicity of precursors. Alternatively, the hydrophobic sol-gel coatings may be formed by a multiplicity of applications of a single alkoxysilane precursor or of multiple precursors. In other words, the coating may comprise a single layer or multiple layers and each layer may comprise a single precursor or multiple precursors.

Regardless of the manner in which the coating is formed, the dried coating is preferably at least about 0.5 μm thick, and more preferably the minimum thickness is between about 1 and about 2 μm. Additionally, it is generally preferable for the coating to have a thickness that is no greater than about 50 μm, and more preferably no greater than about 25 μm, if only for the purpose of decreasing material and processing costs. Also, not exceeding the foregoing thicknesses helps to prevent cracking of a coating due to drying stresses. Thus, in certain embodiments, the thickness of the coating is preferably between about 1 μm and about 10 μm, and more preferably between about 1 μm and about 5 μm. It should be noted, however, that thicknesses exceeding the foregoing ranges may be desirable for applications in which the coating would be subjected to high wear.

Also, it is preferable for each application (i.e., single layer) to be at least about 0.5 μm thick, and more preferably the single layer minimum thickness is between about 1 and about 2 μm. At the other end, it is generally preferable for each application or layer to be no greater than about 100 μm thick, and more preferably no greater than about 50 μm thick because of the cracking. Additionally, it should be noted that experimental results to date indicate that the optimum thickness range for maximizing hydrophobicity is from about 10 to about 50 μm. As such, in certain embodiments, the thickness of a single precursor layer is between about 1 about 50 μm, and more preferably between about 1 and about 20 μm.

In view of the foregoing, the sol-gel process and compositions of the present invention tend to have one or more of the following advantages over prior art organic polymeric materials for forming hydrophobic or superhydrophobic coatings: 1) low temperature preparation, 2) high purity of the final material due to the quality of the available precursors, 3) the ability to control structure and composition of the final material at the molecular level, 4) the ability to tailor the textural properties such as surface area and pore size distribution, 5) optical transparency above 300 nm, 6) the ability to introduce multi-constituents in a single step, 7) high homogeneity in multi-component glasses, 8) the ability to form the gels or glasses in different physical forms such as a monolith, a thin film, and particulate, and 9) simple synthesis and working

In addition to mimicking the composition of the waxy layer of the lotus leaf, the surface of the coating is preferably configured to mimic the surface roughness of the lotus leaf to enhance the hydrophobicity, to provide self-cleaning, or both. Thus, in certain embodiments of the invention the surface of the sol-gel is configured with a surface roughness of a type and degree such that the hydrophobicity of the surface is enhanced and preferably maximized for the particular coating composition. In general, in these embodiments of the invention the surface has a microroughness, topography, or morphology that is appropriate for decreasing and preferably minimizing the contact area between the surface and a water droplet. The manner in which the microroughness is formed on the surface is described in greater detail below.

The microroughness or topography of the coating surface may be characterized or evaluated by scanning electron microscopy and surface profilometry. When so characterized, the degree of microroughness on the surface is typically between about 1 micron and about 2 mm. Based on the following teachings, it will be evident to those skilled in the art that for a particular precursor or combination of precursors selecting the type and degree of microroughness necessary to achieve a desired level of hydrophobicity or to maximize the hydrophobicity may be accomplished through routine testing. Alternatively, routine testing may be performed to select an appropriate sol-gel precursor or combination of precursors needed to achieve a desired level of hydrophobicity for a substrate having a type and degree of surface roughness.

A particularly preferred method for creating or micropatterning a sol-gel coating involves what is herein referred to as “templating.” In general, the templating process comprises contacting the surface to be coated with the sol-gel (i.e., substrate surface) with the surface of the template; applying or depositing the sol onto the substrate surface, while the template is in contact with the substrate surface, so that sol is placed, deposited, or flows around the template; while maintaining the position of the template, the sol is allowed to gel; and removing the template after the liquid sol has sufficiently converted to the solid gel so that the an impression of the template remains in or on the gel. Alternatively, the sol may be applied or deposited on the substrate surface and the template applied thereto while the sol is still considered a liquid, or stated another way, before the sol's viscosity substantially increases.

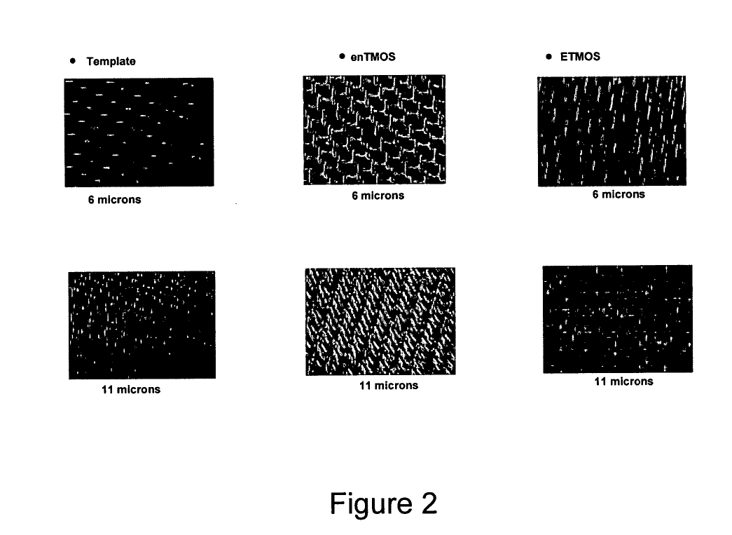

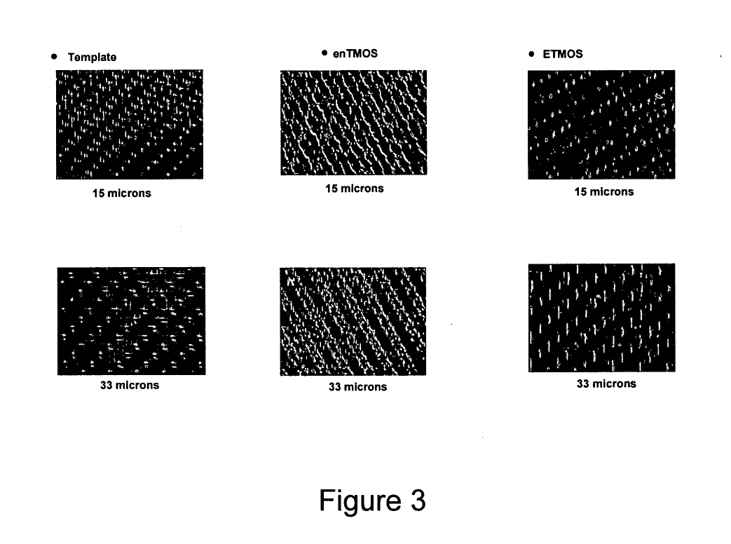

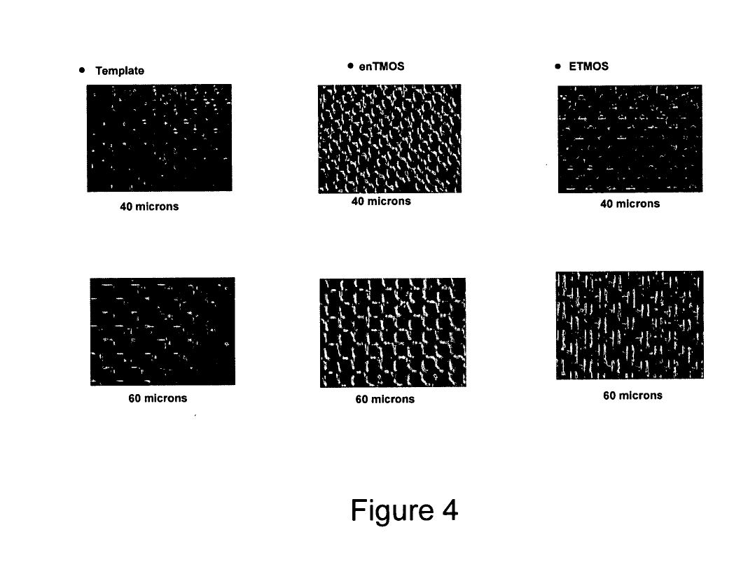

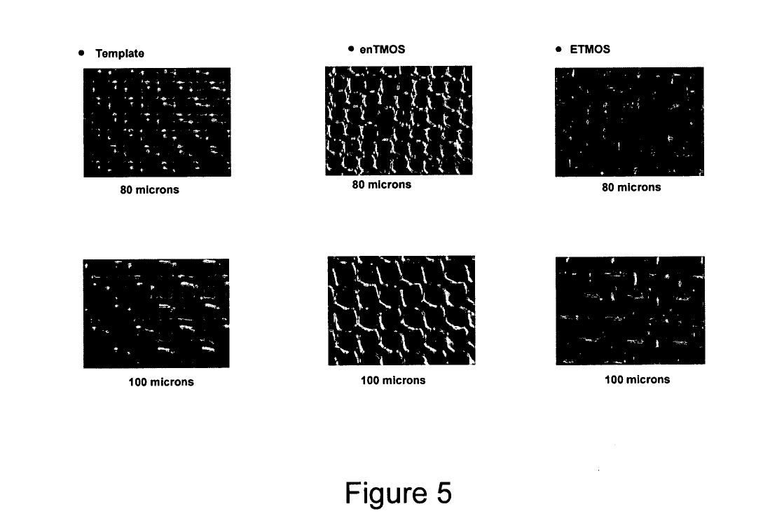

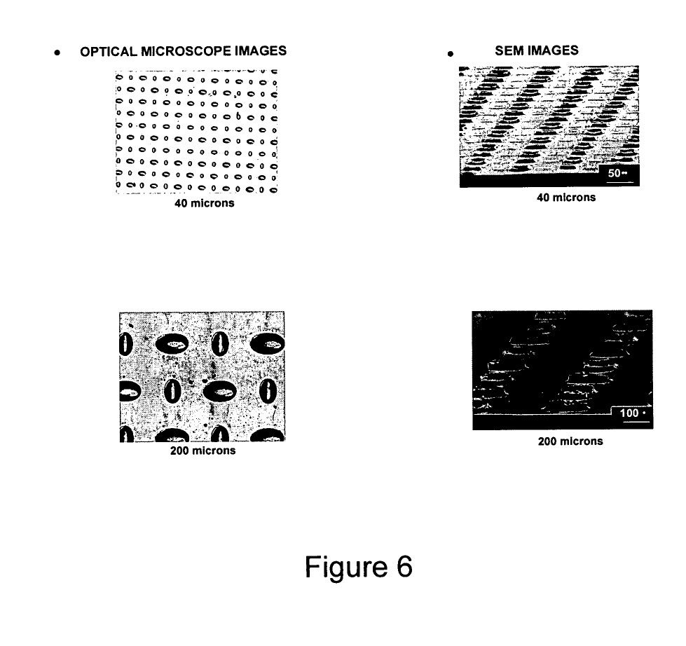

The exact nature of the templated surface depends, in large part, on the type of template (i.e., whether it is an interacting or non-interacting template). Preferably, the template comprises a surface that is an organic polymer that may comprise a hydrophobic group (e.g., an alkyl or aryl group); a hydrophilic functional group that contains, for example, —N, —O, or —S atoms; or a combination thereof. Preferably, the template does not bond or stick to a substrate upon coming in contact therewith. Examples of suitable organic polymers include polyester, polyamide, and polypropylene. Polyester and polyamide templates are considered to be interacting template materials because they tend to hydrogen bond with sol-gels, and as a result surface of the templated coating tends to be a relatively exact negative image of the template that may even include extremely small details (see, e.g., FIGS. 2-5). It was observed that polyester templates were particularly suited for forming square channel-like structures in the gel. In contrast, polypropylene is considered to be a non-interacting template material because it tends not to bond with sol-gels, and as result the sol-gel tends to move away from the template features and aggregate in open volumes (see, e.g., FIG. 6). Thus, different patterns may be formed in or on the sol-gel coating by selecting the type of template material.

Also, the nature of the templated surface depends on the template pattern or features. For example, whether the template pattern comprises elevated features (bumps) extending outward from a surface or depressions (hollows) extending inward from a surface) will affect the templated surface. The primary difference between the two types of features is the range of sizes that tend to be appropriate for imparting the surface microroughness necessary to decrease the water contact area. Specifically, the dimensions (e.g., the cross-section and depth) of appropriately sized hollows tends to be larger than that for bumps. For example, acceptable hollow sizes typically are between about 500 nm and about 5 mm in size and preferably between about 1 μm and about 2 mm, whereas acceptable bumps are typically between about 500 nm and about 500 μm and preferably between about 1 μm and about 100 μm. A template may comprise both bumps and hollows. The shape of the features (elevated or depressed) tends not to be a significant factor. Acceptable results may be achieved with essentially any shape such as hemi-sphere or geometric shapes having three to ten sides.

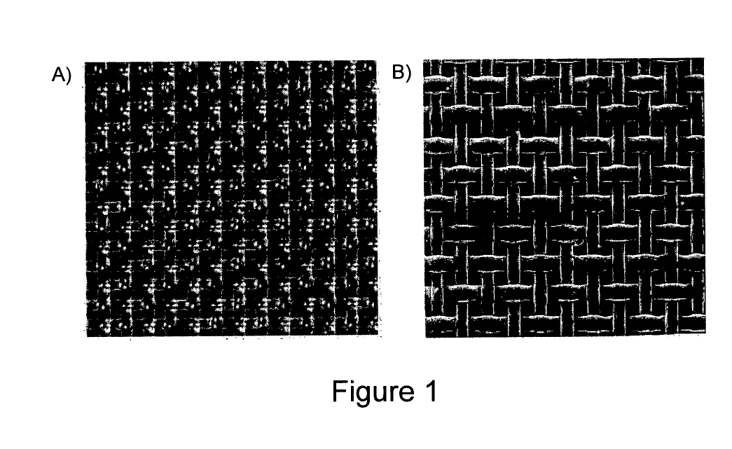

Templates may be formed by any appropriate method. One such method comprises selecting a fabric having the appropriate weave or feature size(s) and coating it with the desired organic or sol-gel polymer according any appropriate method. FIG. 1 is an SEM image of such a fabric substrate template having hollows or depressions that are about 60 μm in size. Using a template having features such as depicted in FIG. 1 and having an interacting polyester surface tends to form a square channel-like templated surface (see, e.g., FIG. 2-5). In contract, the exact same template pattern with a non-interacting polypropylene surface tends to form a templated surface that resembles square islands (see, e.g., FIG. 6).

It should be noted that the viscosity of the sol being templated also plays a role in the patterning. Specifically, less viscous sols tend to allow raised features of the template to contact the substrate and hollows tend not to be entirely filled with the sol. In contrast, more viscous sols tend to resist raised features from contacting the substrate and hollows tend to be entirely filed with the sol.

As an alternative to soft lithography, superhydrophobicity may be imparted by applying a hydrophobic sol-gel coating to a substrate having a surface with the desired degree and type of microroughness. An example of such a substrate may be a fabric formed with an appropriate weave. Such a hydrophobic/superhydrophobic fabric may, advantageously, maintain its breathability (i.e., allow vapor transport of perspiration away from the wearer).

Another technique for introducing micropatterning comprises including appropriately sized particles or crystals in the sol-gel coating. The appropriate size of the particles or crystals is generally between about 0.01 and about 50 μm in size and preferably between about 0.05 and about 20 μm. Further, the concentration or amount of particles or crystals is generally at least about 0.01 g of particles per 1 mL of sol and no greater than about 1 g of particles per 1 mL of sol. Preferably, the concentration of particles is between about 0.05 and about 0.5 g/mL.

As with the other methods of patterning or forming microroughness, the shape of the particles does not tend to significantly affect the hydrophobicity. Acceptable results may be achieved with essentially any shape such as spherical, tetrahedral, cubic, hexagonal, etc. Additionally, the degree of particle cross-sectional uniformity may vary substantially. In other words, the particles may range from having a substantially uniform cross-section (e.g., a relatively solid particle) to a substantially non-uniform particle (e.g., having hollow core). Still further, the particles may be generally porous or nonporous.

Examples of appropriate particles or crystals may comprise: inorganic metal oxide-based materials such as Stöber silica particles, alumina particles, including suspensions thereof such as BUEHLER MICROPOLISH II; or organic polymer-based materials comprising nonpolar groups such as poly (alkyl) or poly (styrene), polar groups with —N, —O, or —S atoms, or a combination of thereof. Although not necessary, the inorganic metal oxide-based materials may be synthesized, for example, using metal alkoxides. The organic polymer-based materials may be synthesized, for example, using metal halide precursors that comprise the nonpolar groups, the polar groups, or a combination thereof. Alternatively, the particles or crystals may be biologically derived such as large proteins, cells, or aggregates of proteins. Additionally, it may be desirable for the particles or crystals to be formed from, or comprise a material that comprises one or more photoionizable functional groups. Advantageously, such particles would change their affinity towards water when irradiated with light. For example, exposure to light may be used to ionize the functional groups, which typically tends to increase the hydrophilicity of the material. Thus, it is possible for such a material to be hydrophobic when not exposed to light and to be hydrophilic when irradiated. Additionally or alternatively, the degree of hydrophilicity may be controlled by the amount of light.

In one embodiment of the present invention, it is desirable for the particles to be dispersed homogeneously throughout the sol before it is deposited onto the substrate. The dispersal may be accomplished by any appropriate method such as stirring, shaking, sonication, etc. To maintain the homogeneous dispersal after deposition on the substrate, it has been discovered that the sol is preferably sufficiently viscous so that the particles tend not to agglomerate on the substrate. One the other hand, the viscosity of the sol is preferably not so great so as to result in cracking of the coating due to the sol-gel drying too quickly. To avoid both of the foregoing problems, it has been discovered that the sol preferably further comprise an additional volume of solvent, which is preferably water. For water, it has been discovered that the volume ratio of sol to water is preferably between about 25:10 and about 25:50, and more preferably between about 25:25 and about 25:35. It should be noted that the proportion of solvent/water to the sol-gel necessary to produce a uniform and non-cracking coating tends to vary with the size of the particles. Specifically, as the particle size increases, the amount of water tends to decrease since smaller particles have a larger surface areas and tend to adsorb more water.

In addition or alternatively, the particles or crystals may be distributed homogeneously throughout the sol-gel coating by way of covalent or non-covalent interactions, or by controlling the chemical composition of the sol-gel precursor. For example, the dispersion of particles may be sufficiently maintained by the addition of a chemical such as polyethylene glycol. More specifically, the dispersion of particles in the composition of Example 1 (below) by adding about 10 volume % of polyethylene glycol (MW 200 to 600) to the sol. Similarly, the dispersion of particles may be maintained in a sol similar to that Example 2. For example, MTMOS may be substituted with carboxyethylsilane triol sol (CET) formed, for example, by mixing 1.75 ml of the precursor with 0.5 ml of water. Then the CET sol may be mixed with the DMDS sol at a volume ratio that is between about 50:50 and about 25:75 (CET:DMDS), which is then mixed with ODT and water in a manner consistent with that of Example 2.

Yet another alternative for creating the desired degree of microroughness on the hydrophobic sol-gel coating comprises mechanically altering the surface of the sol-gel coating. For example, a sol-gel coating may be scratched or indented in a controlled manner, which is known to those skilled in the art.

Still further, controlled chemical etching (e.g., through a polymeric etching template having openings of the appropriate size e.g., about 10 nm to about 5 mm) of the sol-gel coating may be used to create the microroughness.

It should be noted than any combination of the foregoing methods of creating microroughness on the surface of the sol-gel coating may be used. For example, it is possible that soft lithography may be combined with including particles or with using a patterned substrate. Additionally, it is possible to create the desire surface by patterning a single layer of a multi-layer coating. For example, a non-hydrophobic sol-gel layer may be patterned using soft lithography and a hydrophobic sol-gel layer may be formed or deposited thereon.

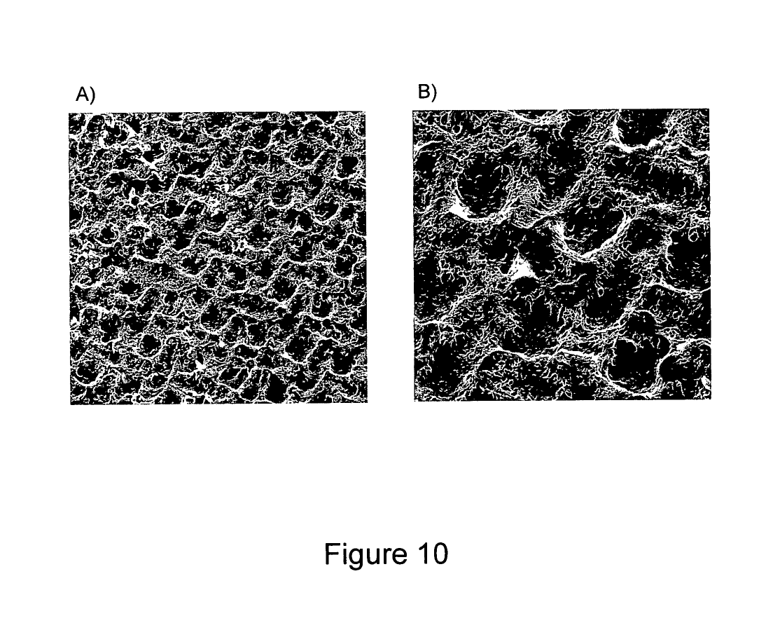

In addition to the above-described micropatterning/microroughness at the surface of the hydrophobic coating, it may, in certain embodiments, be desirable to create a surface topography or roughness comprising hair-like features similar to that found on a lotus leaf. The scale of such hair-like features may be between about 0.5 and about 5 μm, and may be formed by depositing a precursor with a long chain alkyl (e.g., an alkyl comprising at least 4 carbon atoms, typically between 4 and 18 carbon atoms). For example, such features were observed by depositing octadecyltrimethoxysilane (ODT), which comprises an 18-carbon long chain alkyl, on a layer formed from enTMOS and DMDS precursors (see, FIG. 10). These hair-like features tend to further enhance the hydrophobicity of the surface. Also, they impart the property of self cleaning to the surface. If present, the hair-like features are preferably formed on the outermost layer of the hydrophobic coating.

### EXAMPLES

### Example 1

### Templated Sol-Gel Coatings

Different sol-gel coatings were made using combinations of a different organosilica precursors according to several different procedures. In general, the first procedure comprised depositing a layer of sol comprising a single organosilica precursor onto a glass substrate and then forming a surface relief on the layer by applying a template during the curing or gelling of the sol. Both Bis-[3-(trimethoxysilyl)-propyl]-ethylenediamine (enTMOS), having the formula of (CH₃O)₃Si(CH₂)₃NH(CH₂)₂NH(CH₂)₃Si(OCH₃)₃, and ethyltrimethoxysilane (ETMOS), having the formula (CH₃O)₃SiCH₂CH₃, were tested in this manner. The second procedure generally comprised depositing a first layer of an organosilica precursor allowing the first layer to gel or cure, applying a second layer of a different organosilica precursor and templating the second layer of precursor during its gelation. This second procedure was performed with the following combinations: (a) enTMOS on ETMOS, (b) ETMOS on enTMOS, and (c) n-butyltrimethoxy silane (BTMOS), having the formula of (CH₃O)₃Si(CH₂)₃CH₃, on enTMOS. The third procedure involved forming three component coatings. Specifically, a mixture of enTMOS and dimethyldimethoxysilane (DMDS), having the formula (CH₃O)₂Si(CH₃)₂, were applied as a single layer and were templated during gelation. Then, a uniform layer of a sol made up of n-octadecyltrimethoxy silane (ODT), having the formula (CH₃O)₃Si(CH₂)₁₇CH₃, was applied to the first layer.

The different sols were prepared as follows. The enTMOS sol was prepared by mixing about 0.5 mL of enTMOS precursor, about 3 mL or methanol and about 0.2 mL or water and sonicating the mixture for about 10 minutes. The enTMOS precursor is basic and hence, the gelation reaction is self-catalyzed, that is, the addition of base as a catalyst is not required). The ETMOS sol was prepared by mixing about 0.3 mL of ETMOS precursor, about 0.8 mL of water and about 0.176 mL of about 0.04 M HCl and sonicating the mixture for about 20 minutes. This sonicated mixture was then mixed with about 0.994 mL of about 0.1 M (pH about 7) phosphate buffer to make a homogenous sol before coating on the glass substrate. The BTMOS sol was prepared by mixing about 0.75 mL of BTMOS precursor, about 4.5 mL of methanol, about 0.2 mL of water, and about 0.044 mL of about 0.044 M HCl and sonicating the mixture for about 20 minutes. This mixture was then mixed with about 5.5 mL of about 0.1 M (pH about7) phosphate buffer to make a homogenous sol. The enTMOS+DMDS sols were prepared by mixing enTMOS and DMDS sols in differing enTMOS to DMDS molar ratios of about 1:1, 1:2, 1:3, 1:4, 1:5 and 1:6. This enTMOS sol was prepared by sonicating a mixture of about 1.5 mL of methanol, about 0.3 mL of enTMOS precursor, and about 0.1 mL of water for a period of about 10 minutes. The DMDS sol was prepared by sonicating a mixture of about 2 mL of methanol, about 0.5 mL of DMDS precursor, about 0.3 mL of water and about 0.1 mL of about 0.04 M HCl for a period of about 60 minutes. Lastly, the ODT sol was prepared by stirring a mixture of about 15 mL of 1-propanol, which 1-propanol is a primary ingredient in the commercially available water-repellent sprays, about 0.15 mL of ODT precursor, about 0.1 mL of water and about 0.1 mL of about 0.04 M HCl for a period of 15 minutes under ambient conditions.

The templating or micro-patterning of the single precursor sol-gel coatings was accomplished by placing an organic template having a feature size of about 6, 11, 15, 27, 33, 40, 60, 80, 100, 120, 149, 160, 180, or 200 μm on the deposited layer of sol. The coatings were then dried, with the template thereof, in an oven maintained at about 160° C. The glass substrate having the layer of enTMOS was dried for about 5 minutes, whereas the ETMOS layer was dried for between about 10 and about 15 minutes. After the samples were dried, the templates were removed leaving a relief on the surface of the sol-gel coating.

The two layer-two precursor sol-gel coatings were prepared by applying the first layer, drying overnight under ambient conditions, applying the second layer, applying the above described template to the second layer, and drying the second layer with the template thereon. The drying of the second layer was accomplished by placing the substrate in an oven maintained at about 160° C. for a period of about 15 to about 20 minutes for the ETMOS and BTMOS sols and about 5 minutes for the enTMOS sol. After the samples were dried, the templates were removed leaving a relief on the surface of the sol-gel coating.

The enTMOS+DMDS sol-gel coatings were prepared by applying about 0.12 mL of the two-component sol to the glass substrates. Templates with a pore size of about 15, 27, 40, 60, 80, 100, 120, 149, 160, or 200 μm were applied and the layers were dried with the templates thereon under ambient conditions for a period of one day. The molar ratio of about 1:6 for enTMOS:DMDS was selected to form the two layer-three precursor sol gel coatings because this ratio of enTMOS to DMDS was determined to have the maximum contact angle, which indicates the greatest water repellency (see FIG. 7). Specifically, after removal of the template, the composite comprising the glass slide and the layer or coating of 1:6 enTMOS+DMDS sol-gel was immersed in the ODT sol for about 12 hours. During this period, the ODT sol was in an open beaker, which allowed a slow evaporation of the solvent to uniformly deposit ODT sol particles on the templated enTMOS+DMDS sol-gel coating.

The contact angle of a water drop on the surface of each of the patterned sol-gel films was measured using a Tantech contact angle meter, model CAM-Micro. The results of the measurements are set forth in FIG. 7. The contact angle indicates the extent of water repellency of these coatings, with higher contact angle values indicating a greater water repellency. The data in FIG. 7 indicates that the contact angles were found to be higher for the two component coating comprising an enTMOS base layer and a BTMOS top layer. Without being held to a particular theory, this may be due the greater hydrophobicity of the butyl group as compared to the ethyl group.

The data represented in FIG. 7 also indicates that there are trends in the relationship between the contact angle (hydrophobicity) and the surface relief of the sol-gel coating. First, the data indicates that the hydrophobicity tends to increase to a maximum value with increasing template pore size until a pore size of about 15 μm regardless of the coating composition. Additionally, each of the coatings has range of pore sizes that it may be templated with to yield its approximate maximum or optimum contact angle (hydrophobicity). In other words, there seems to be a plateau in the contact angle versus template pore size relationship. Specifically, the contact angle plateau may be formed by using a template having pore sizes that range between a minimum optimum pore size of about 15 μm to a maximum optimum pore size that varies depending on the sol-gel precursor being templated. For example, the composite comprising an enTMOS base layer and a BTMOS top layer had a maximum optimum template pore size of about 60 μm. In contrast, the composites comprising the ETMOS base layer and enTMOS top layer, and the enTMOS base layer and the ETMOS top layer had a maximum optimum template pore size of about 40 μm. Still further, as the template pore size increased from the maximum optimum template pore size the contact angle gradually decreased until the water drop wet about 180 to about 200 μm templated surfaces. Also, the contact angles were found to be higher for the two component coating consisting of enTMOS base layer and BTMOS top layer. This may be due the greater hydrophobicity of the butyl group as compared to ethyl group.

The surfaces of the patterned sol-gel coatings were also evaluated using optical and scanning electron microscopy. The single and two precursor coatings were imaged with an optical microscope to verify the formation of micropatterns in, or on the sol-gel coatings. FIGS. 2-5 show the optical images of the 6, 11, 15, 33, 40, 60, 80, and 100 μm templates and the single layer coatings formed from enTMOS or ETMOS that were templated therewith. The images show a continuous and homogenous replication of the templates on the sol-gel coating, with no apparent cracking or peeling of the coatings. As can be seen from these images, the features of the patterned surface are different for enTMOS and ETMOS despite the fact that the same templates were used. Without being held to particular theory, it is believed that the difference in the patterning is due to the composition and the consistency of the sol. With respect to consistency, it is believed that as the viscosity of a sol is increased, the sol tends to be patterned in a manner that the holes in between the template walls become filled with the sol. This seems to be how the ETMOS sol-gel was patterned. On the other hand, as the viscosity of a sol is decreased, the holes between the template wall tend to not be filled so the pattern tends to be formed primarily by the points of contact between the glass substrate and the template. This seems to be how the enTMOS sol-gel was patterned.

It should be noted that for the samples comprising a first or base layer of enTMOS that was not patterned followed by a second layer of ETMOS that was patterned, the pattern structure was different from the single layer of patterned ETMOS. Without being held to a particular theory, it is believed that the difference in the pattern was due, at least in part, to the hydrophobic nature of the ETMOS, which resulted in self aggregation and less interaction with the enTMOS base layer than with the bare substrate.

The three component coatings were imaged with a Hitachi S570 SEM instrument to verify the formation of the micropatterns on the sol-gel coating for these coatings. The samples were coated with a 350 Angstrom layer of gold-palladium to enable the SEM imaging. Additionally, the SEM imaging was performed before and after the ODT sol deposition.

The results of the contact angle measurements for the enTMOS+DMDS non-patterned sol-gel coatings at the various molar ratios are shown in FIG. 8. The results indicate an increase in contact angle with increasing proportion of DMDS in the composition. Without being held to a particular theory, it is believed that the greater hydrophobicity of the higher concentrations of DMDS may be due, at least in part, to the fact that DMDS has more hydrophobic groups. Additionally, it is believed that the increasing hydrophobicity with increasing DMDS concentration may reside, at least in part, in the fact that the R′ groups only comprise methyl (—CH₃) groups, which have lower surface energy than methylene (—CH₂—) groups.

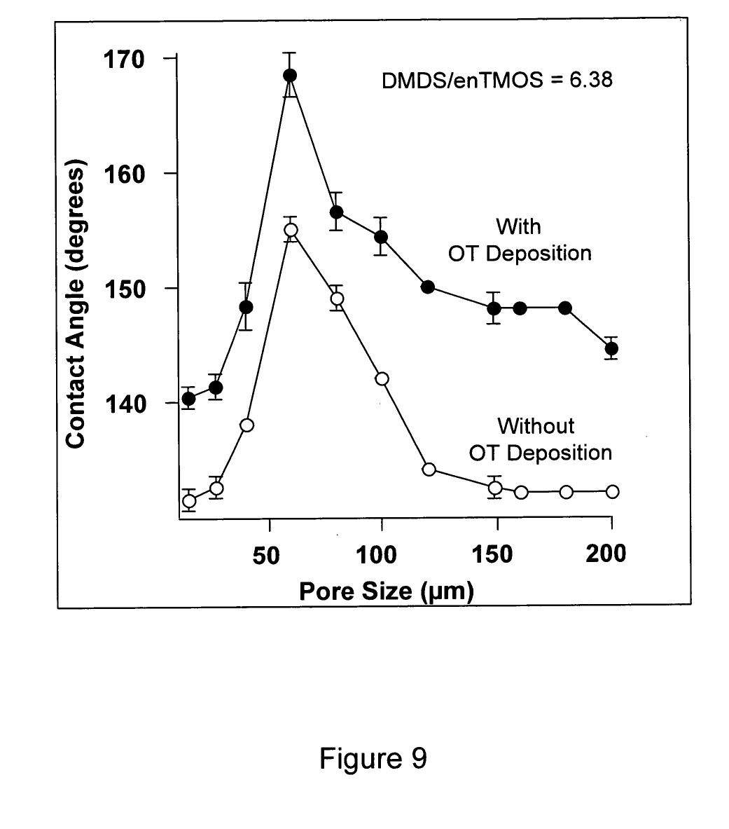

The data represented in FIG. 9 indicates that depositing ODT over a patterned enTMOS+DMDS sol-gel coating enhances water repellency. Without being held to a particular theory, it is believed that the ODT deposition enhances water repellency because of its relatively long 18-carbon alkyl R′ group mimics the composition of the lotus leaf “waxy” layer and forms hair-like features on the scale-like micropatterned surface of the enTMOS+DMDS sol-gel coating that mimic the protrusions on a lotus leaf. The hair-like features from the ODT are visible in the SEM images of FIG. 10.

Like FIG. 7, FIG. 9 shows that there is a trend of increasing contact angle with increasing template pore size. In contrast to the single precursor coatings, however, the peak contact angle for the enTMOS+DMDS coating (with and without ODT deposition) occurred when the template pore size was about 60 μm. Further, unlike the single precursor coating, there does not appear to be a relatively broad range of template porosities that produce a maximum or near maximum contact angle.

In addition to water-repellency, the ODT deposited-enTMOS+DMDS patterned surface was determined to be self-cleaning like a lotus leaf. This was determined by the fact that a water drop deposited on the coating removed all the graphite powder (dirt particles) on the surface of the coating as the water drop was rolled over the templated surface.

### Example 2

### Hydrophobic Sol-Gel Coating on Fabric

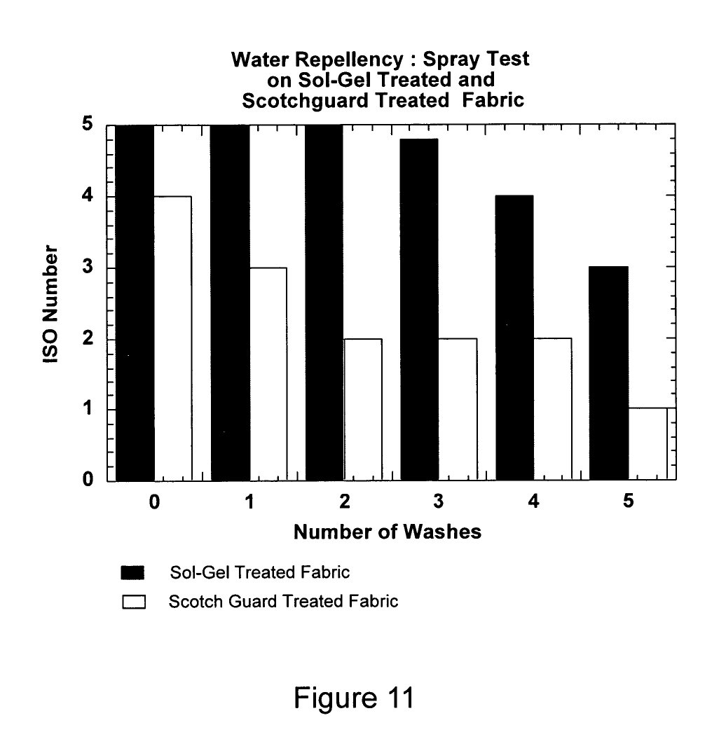

Cotton fabric was coated with ODT sol-gel to evaluate its ability to impart water-proofing properties to the fabric. Pieces of cotton fabric (commercially available from Wal Mart) were coated with ODT sol that was prepared as described above and applied using a commercially available trigger-pump aerosol spray bottle. The fabric pieces having the aerosol of ODT sprayed thereon were dried for a period of 24 hours before they were tested for their water-proof capability. The following day, these fabric pieces exhibited the lotus leaf effect (e.g., a deposited water drop maintained a spherical shape and was retained on the surface), whereas the water drops applied to uncoated ODT fabric pieces were absorbed by the fabric. Additionally, the lotus leaf effect was retained on the ODT coated cotton fabric after washing the fabric with SURF brand powdered detergent. Specifically, the water repellency of the ODT treated fabric and a SCOTCH GUARD treated fabric were compared as a function of washes and the results are set forth in FIG. 11. Further, the ODT coated cotton fabric was also found to have a self-cleaning property. Specifically, a water drop that was rolled on the soiled surface of the ODT coated fabric removed all dirt particles (i.e., graphite powder) from the surface.

### Example 3

### Non-Templated Sol-Gel Coatings

The materials used in this example include 3-aminopropyltrimethoxysilane, trimethylmethoxysilane, 2-cyanoethyltriethoxysilane, tridecafluoro-(1,1,2,2-tetrahydroxyoctyl)triethoxysilane (TFT), hexyltrimethoxysilane (HT), dimethyidimethoxysilane (DMDS), trimethylmethoxysilane, octyltrimethoxysilane (OT), n-octadecyltrimethoxysilane (ODT), hexyltrimethoxysilane (HT), and hexadecyltrimethoxysilane (HDT) obtained from Gelest. The t-butanol, absolute ethanol, iso-propanol, trizma base, sucrose, and urea were obtained from Aldrich.

The foregoing materials were used to prepare the sols set forth in Table A, which were spayed using a commercially available trigger-pump spray bottle onto glass slides. The sol-gels sprayed onto the glass slides were dried at 160° C. for about one day and the contact angle of the dried coating was measured.

TABLE A

| Sample | Composition | Contact Angle |
|---|---|---|
| HB.1 | 1.7 ml HB sol and 0.57 ml absolute ethanol | about 120° |
| | The HB sol comprised: 0.15 ml of 2- | |
| | cyanoethyltrimethoxysilane, 0.075 ml of TFT, | |
| | 0.075 ml of HT, 0.5 ml of t-butanol, 0.07 ml of | |
| | water, and 01 ml of 0.5M HCl, and was sonicated | |
| | for 30 minutes. | |
| HB.2 | 0.1 ml of trimethylmethoxysilane and 1 ml of absolute | between about |
| | ethanol | 100° and about |
| | | 110° |
| HB.3 | 0.125 ml OT sol, 0.875 ml DMDS sol, and 0.055 ml ODT | about 110° |
| | sol mixed and sonicated for 30 minutes | |
| | The OT sol comprised: 4.5 ml of ethanol, 1.5 ml | |
| | of OT, 0.6 ml of water, 0.15 ml of 0.04M HCl, and | |
| | was sonicated for 30 minutes. | |
| | The DMDS sol comprised: 4.5 ml of ethanol, 1.5 ml | |
| | of DMDS, and 0.3 ml of water, and was | |
| | sonicated for 30 minutes. | |
| | The ODT sol comprised: 5 ml of ethanol, 0.1 ml of ODT, and | |
| | was sonicated for 30 minutes. | |
| HB.4 | Same as HB.3 except that the ODT sol comprised 3.5 ml | between about |
| | of isopropanol instead of 5 ml of ethanol. | 110° and about |
| | | 120° |

The sols set forth in Table B, which were sonicated for 45 minutes before being sprayed on cotton fabric. The stabilities of the sol compositions set forth in Table B were evaluated along with the hydrophobicity of the treated fabric samples and the results are set forth in Table C.

TABLE B

| Sample | Composition |
|---|---|
| HB-F.01 | Ethanol(50 mL) + ODT precursor(0.3 mL) + water(0.2 mL) + HCl[0.04M](0.2 mL) |
| HB-F.02 | Ethanol(50 mL) + ODT precursor(6 mL) + water(0.2 mL) + HCl[0.04M](0.2 mL) |
| HB-F.03 | Ethanol(50 mL) + ODT precursor(6 mL) + water(0.6 mL) + HCl[0.04M](0.6 mL) |
| HB-F.04 | Ethanol(50 mL) + ODT precursor(6 mL) + water(1 mL) + HCl[0.04M](0.2 mL) |
| HB-F.05 | Ethanol(50 mL) + ODT precursor(6 mL) + water(1 mL) |
| HB-F.06 | Ethanol(50 mL) + ODT precursor(6 mL) + water(2 mL) |
| HB-F.07 | Ethanol(50 mL) + ODT precursor(6 mL) + water(0.2 mL) + HCl[0.04M](0.1 mL) |
| HB-F.08 | Ethanol(50 mL) + HDT precursor(6 mL) + water(0.2 mL) + HCl[0.04M](0.1 mL |
| HB-F.09 | 1-propanol(50 mL) + ODTprecursor(6 mL) + water(0.2 mL) + HCl[0.04M](0.1 mL) |
| HB-F.10 | Ethanol(50 mL) + ODT precursor(6 mL) + water(1 mL) |
| HB-F.11 | Ethanol(50 mL) + ODT precursor(6 mL) + water(0.5 mL) |
| HB-F.12 | Ethanol(50 mL) + ODT precursor(4 mL) + water(1 mL) |
| HB-F.13 | Ethanol(50 mL) + ODT precursor(4 mL) + water(0.5 mL) |
| HB-F.14 | Isopropanol(50 mL) + ODT precursor (6 mL) + water(1 mL) |
| HB-F.15 | Isopropanol(50 mL) + ODT precursor (6 mL) + Water (0.5 mL) |
| HB-F.16 | Isopropanol(50 mL) + ODT precursor (6 mL) + Water (25 mL) |
| HB-F.17 | Isopropanol(50 mL) + ODT precursor (3.6 mL) + Water (25 mL) |
| HB-F.18 | Ethanol(50 mL) + ODT precursor(6 mL) + Water (0.25 mL) |
| HB-F.19 | Ethanol(50 mL) + ODT precursor(4 mL) + Water (0.25 mL) |
| HB-F.20 | Ethanol(50 mL) + ODT precursor(3 mL) + Water (1 mL) |
| HB-F.21 | Ethanol(50 mL) + ODT precursor(3 mL) + Water (0.5 mL) |
| HB-F.22 | Ethanol(50 mL) + ODT precursor(3 mL) + Water (0.25 mL) |
| HB-F.23 | Ethanol(50 mL) + HDT precursor(2 mL) + ODT precursor(2 mL) + Water(0.5 mL) |
| HB-F.24 | Ethanol(50 mL) + HDT precursor(2 mL) + ODT precursor(1 mL) + Water(0.5 mL) |
| HB-F.25 | Ethanol(50 mL) + HDT precursor(1 mL) + ODT precursor(2 mL) + Water(0.5 mL) |
| HB-F.26 | Ethanol(50 mL) + ODT precursor(5 mL) + TFT(5 ml) + Water(0.5 mL) |
| HB-F.27 | Ethanol(50 mL) + ODT precursor(5 mL) + TFT(2.5 ml) + Water(0.5 mL) |
| HB-F.28 | Ethanol(50 mL) + ODT precursor(2.5 mL) + TFT(5 ml) + Water(0.5 mL) |
| HB-F.29 | Ethanol(50 mL) + OT precursor(6 mL) + Water(0.25 mL) |
| HB-F.30 | Ethanol(50 mL) + OT precursor(4 mL) + Water(0.25 mL) |
| HB-F.31 | Ethanol(50 mL) + OT precursor(3 mL) + Water(0.25 mL) |
| HB-F.32 | Ethanol(50 mL) + OT precursor(5 mL) + TFT precursor(5 mL) + Water(0.5 mL) |
| HB-F.33 | Ethanol(50 mL) + OT precursor(5 mL) + TFT precursor(2.5 mL) + Water(0.5 mL) |
| HB-F.34 | Ethanol(50 mL) + OT precursor(2.5 mL) + TFT precursor(5 mL) + Water(0.5 mL) |
| HB-F.35 | Ethanol(50 mL) + HDT precursor(5 mL) + TFT precursor(5 mL) + Water (0.5 mL) |
| HB-F.36 | Ethanol(50 mL) + HDT precursor(5 mL) + TFT precursor(2.5 mL) + Water(0.5 mL) |
| HB-F.37 | Ethanol(50 mL) + HDT precursor(2.5 mL) + TFT precursor(5 mL) + Water(0.5 mL) |
| HB-F.38 | Ethanol(50 mL) + HT precursor(5 mL) + TFT precursor(5 mL) + Water (0.5 mL) |
| HB-F.39 | Ethanol(50 mL) + HT precursor(5 mL) + TFT precursor(2.5 mL) + Water (0.5 mL) |
| HB-F.40 | Ethanol(50 mL) + HT precursor(2.5 mL) + TFT precursor(5 mL) + Water (0.5 mL) |

TABLE C

| Sample | Stability of Sol | Hydrophobicity |
|---|---|---|
| HB-F.01 | clear for 2-3 months | poor |
| HB-F.02 | turbid after 3 days | good |
| HB-F.03 | sonication results in heavy precipitation | not applied |
| HB-F.04 | initially clear, precipitation formed overnight | not applied |
| HB-F.05 | clear for 15 days | poor |
| HB-F.06 | turbid after 7 days | poor |
| HB-F.07 | turbid after 7 days | poor |
| HB-F.08 | sonication results in heavy precipitation | not applied |
| HB-F.09 | clear | good |
| HB-F.10 | clear for 12 days, then heavy precipitation | good |
| HB-F.11 | clear for 15 days, then heavy precipitation | good |
| HB-F.12 | clear for 15 days, then slid turbidity | good |
| HB-F.13 | clear for 15 days and then slight turbidity | good |
| | after 40 days | |
| HB-F.14 | slight turbidity after 10 days | good |
| HB-F.15 | slight turbidity after 10 days | good |
| HB-F.16 | sonication results in heavy precipitation | not applied |
| HB-F.17 | sonication results in heavy precipitation | not applied |
| HB-F.18 | precipitation after 15 days | good |
| HB-F.19 | clear for a few months | poor |
| HB-F.20 | clear for a few months | poor |
| HB-F.21 | clear for a few months | poor |
| HB-F.22 | turbid after 15 days | poor |
| HB-F.23 | remains clear (10 days) | good |
| HB-F.24 | remains clear (10 days) | good |
| HB-F.25 | remains clear (10 days) | good |
| HB-F.26 | heavy precipitation after 7 days | good |
| HB-F.27 | remains clear (10 days) | good |
| HB-F.28 | remains clear (10 days) | good |
| HB-F.29 | remains clear (10 days) | poor |
| HB-F.30 | remains clear (10 days) | poor |
| HB-F.31 | remains clear (10 days) | poor |
| HB-F.32 | remains clear (10 days) | poor |
| HB-F.33 | remains clear (10 days) | poor |
| HB-F.34 | remains clear (10 days) | poor |
| HB-F.35 | remains clear (10 days) | good |
| HB-F.36 | remains clear (10 days) | good |
| HB-F.37 | remains clear (10 days) | good |
| HB-F.38 | remains clear (10 days) | poor |
| HB-F.39 | remains clear (10 days) | poor |
| HB-F.40 | remains clear (10 days) | poor |

At this time, there is no definitive explanation as to why some of the samples had a good hydrophobicity and others had a poor hydrophobicity. Although there were exceptions, there seems to be trend that compositions with higher amounts of OT, HT, and TFT tended to be more hydrophobic. The importance of sol stability was to evaluate a compositions possible use as a consumer spray for imparting water repellency. For this application, it is believed that a sol should be stable for an extended period.

### Example 4

### Sol-Gel Coatings Comprising Particles

The materials used in this example included methyltrimethoxysilane (MTMOS), dimethyidimethoxysilane (DMDS), octadecyltrimethoxysilane (ODT), MICROPOLISH II from Buehler in 0.05 μm, 0.3 μm, and 1 μm particle sizes, and aluminum oxide powder from Buehler in 5 μm and 20 μm particle sizes, and methanol. The MTMOS sol comprised about 1.5 ml MTMOS precursor, about 0.4 ml H₂O, and about 0.022 ml HCl (0.04M), and the mixture was sonicated for about 30 minutes. The DMDS sol comprised about 2 ml methanol, about 0.5 ml DMDS, about 0.4 ml H₂O, and 0.05 ml HCl(0.04M), and the mixture was sonicated for about 30 minutes.

Individual Sol with Particles

The MTMOS and DMDS sols were mixed with the different sized particles by sonication for about 45 minutes, the sols with the particles dispersed therein were applied to glass slides, allowed to dry, and the contact angles were measured. The coatings made with MTMOS sol and particles produced well adhered coatings having contact angles in the range of about 80° to about 90°. The DMDS coatings, however, were peeling off after a day and had contact angles of about 110°.

### Sol Combinations with Particles

Additionally, the particles were dispersed in a sol comprising a mixture of the DMDS and MTMOS sols at various DMDS:MTMOS volume ratios ranging from about 50:50 to about 95:5. An ODT precursor mixed with 10% ethanol was added to the foregoing DMDS-MTMOS sols at concentrations of 10, 20, and 25 percent by volume of the total sol. After the ODT was added, the mixture was sonicated for about 30 minutes. To the mixtures, the different sized particles were added and the mixture was sonicated for about 45 minutes. The samples were applied to glass slides, allowed to dry, and the contact angles were measured. For example, a sol comprising a volume ratio of DMDS sol to MTMOS sol of about 95:5, a volume ratio of DMDS-MTMOS sol to ODT (10% ethanol) of about 83:17, and 0.05 μm MICROPOLISH II particles at a concentration of about 0.1 g per mL of sol yielded a coating having a contact angle of about 156°. Additionally, the same sol with about 0.4 grams of 5 μm aluminum oxide particles per mL of sol, and about 0.45 grams of 20 μm aluminum oxide particles per mL of sol had contact angles of about 122° and 112°, respectively. All these coatings, however, comprised cracks, which may have been the primary reason for the relatively good hydrophobicity. If this was so, it would be difficult to reliably produce these coatings commercially.

### Sol Combinations with MICROPOLISH II Particles and Water

In view of the foregoing, new compositions were tested in an attempt to develop coatings that would not crack. To assure good adherence to the glass slide, the volume ratio of DMDS sol to MTMOS sol was selected to be about 90:10. The particles selected were the 0.05 μm MICROPOLISH II and were added at the to the DMDS-MTMOS sol at a concentration of about 0.1 g per 1 mL of sol. The particles were thoroughly suspended in the sol by vortexing for about 3 minutes. Water was added to the sol containing the particles at water to sol volume ratios of about 25:10, 25:20, 25:30, and 25:50. After the addition of water, the mixture was vortexed. Measured volumes of sol containing the particles (about 50 μl or about 100 μl), were spread with a pipette tip on half a glass slide and the applied sols were dried in an oven at a temperature of about 160° C. for about 24 hrs. The hydrophobicity of these coatings were determined by measuring the contact angle of a 10 μl water drop. The contact angles for these coatings were between about 164 and about 170°. It was also determined that the contact angle for a coating varied by about 4-6° depending on the ambient conditions.

It was discovered that the water to sol volume ratio of about 25:30 provided the most uniform coating. At lesser amounts of water, the film tended to dry too fast, which leads to cracks developing in the materials thereby disrupting the surface microstructure necessary for imparting hydrophobicity. On the other hand, with more water the particles tended to agglomerate on the slides. Additionally, it was observed that the optimum volume ratio of water to sol tended to vary with the ambient conditions.

### Sol Combinations with Alumina Particles and Water

Using the immediately preceding sol compositions (i.e., DMDS-MTMOS with water), hydrophobic coatings prepared with alumina particles of sizes about 0.3 μm, 1 μm, 5 μm and 20 μm. The contact angle measured on several films is set forth Table D below.

TABLE D

| | | Composition (volume | |
|---|---|---|---|
| Particle | Wt. of the | proportion) | Contact |
| size | particles/ml of sol* | Sol A*:water | angle |
| 0.05μ | 0.1 g | 25:30 | 164 |
| 0.3μ | 0.35 | 25:5 | 160 |
| 1μ | 0.35 | 25:10 | 158 |
| 5μ | 0.5 | 25;5 | 130 |
| 20μ | 0.5 | 25:5 | 120 |

*Sol comprised a DMDS sol to MTMOS sol volume ratio of about 90:10.

The coatings in Table D were visually inspected using a microscope and determined to be essentially free of cracks and uniform. Therefore, the hydrophobicity may be attributed to the sol composition and the particles in the coatings. It should be noted that the results indicate that as the size of the particles is increased the contact angle tends to decrease.

In view of the foregoing, the present invention allows for the lotus leaf effect to be successfully mimicked on essentially any material in a relatively simple manner. Unlike other methods known in the art that require exposing the substrate or coating to extreme conditions (e.g., high temperature), the method of the present invention may be accomplished by drying at ambient temperatures or slightly elevated temperatures within 24 hours. The hydrophobic effect may, however, be made more pronounced if the coating is allowed to dry for at least about three to about four days. Other advantages of the present invention include one or more of the following: the silica-based precursor compositions tend to be biocompatible and nondegradable; relatively simple chemical method of preparation under ambient conditions; commercial availability of precursors; essentially any shape may be coated; sols may be applied by a variety of methods such as dipping or spraying; and self-cleaning may be imparted; transparency; physical and chemical stability at high temperatures (e.g., up to about 300° C.) and extreme pH conditions (e.g., pH <1 or >10); and their nano-porous nature, which allows fabric to breath and improves the fungal resistance of a coated surface.

Based on the foregoing advantages of the present invention, possible commercial applications include the following: anti-corrosion water repellant coatings for metals and alloys; self-cleaning coatings for glasses (windows, screens, etc.); general purpose water-repellant coatings with self-cleaning properties for consumer items such as house walls, furniture, etc.; anti-icing coatings in aircraft industry; permanent or semi-permanent treatments to produce for wrinkle-, water-, and soil-proof fabrics; water-repellent coatings for glass surfaces (e.g., building windows, automobile glass, and solar cell surfaces; building wall and windows that are self-cleaning; water-repellent coatings for cellulose derived products such as paper; and water-repellent paints for concrete and wood.

What is claimed is:

1. A composite having a surface that is at least hydrophobic, the composite comprising:
a. a substrate; and
b. a hydrophobic coating on at least a portion of the substrate, the hydrophobic coating being formed from a mixture comprising a sol-gel that comprises an alkoxosilane precursor having a general formula of R′ₓSi(OR)₄₋ₓ or (RO)₃SiR″Si(OR)₃, wherein R and R′ are the same or different and are hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2, and comprising a topography that decreases a contact area between the hydrophobic coating and a water droplet thereon.

2. The composite of claim 1 wherein the topography comprises features that are between about 10 nanometers and about 5 millimeters.

3. The composite of claim 1 wherein the topography comprises features that are between about 10 and about 100 micrometers.

4. The composite of claim 1 wherein the topography comprises features that are between about 15 and about 80 micrometers.

5. The composite of claim 1 wherein the topography comprises features that are between about 20 and about 60 micrometers.

6. The composite of claim 1 wherein the hydrophobic coating further comprises hair-like surface features.

7. The composite of claim 1 wherein the mixture further comprises particulate having a size that between about 0.01 and about 50 μm at a concentration of between about 0.01 and about 1 g of particulate per mL of sol-gel.

8. The composite of claim 1 wherein the mixture further comprises water at a volume ratio of sol-gel to water that is between about 25:10 and about 25:50.

9. The composite of claim 1 wherein the mixture further comprises particulate having a size that between about 0.05 and about 20 μm at a concentration of between about 0.05 and about 0.5 g of particulate per mL of sol-gel.

10. The composite of claim 1 wherein the mixture further comprises water at a volume ratio of sol-gel to water that is between about 25:25 and about 25:35.

11. The composite of claim 1 wherein the mixture further comprises particulate having a size that is about 0.05 micrometers at a concentration of about 0.1 g of particulate per mL of sol-gel, and water at a volume ratio of sol-gel to water that is about 25:30.

12. The composite of claim 1 wherein R′ is —CₙH₂ₙ₊₁, R′ is —(CₙH₂ₙ)—, and n is an integer from 1 to 20.

13. The composite of claim 1 wherein n is an integer from 6 to 18.

14. The composite of claim 1 wherein R is the same or different and is a methyl group or ethyl group.

15. The composite of claim 1 wherein the alkoxosilane precursor comprises ethyltrimethoxysilane, n-butyltrimethoxysilane, hexyltrimethoxysilane, octyltrimethoxysilane, hexadecyltrimethoxysilane, octadecyltrimethoxysilane, dimethyldimethoxysilane, or a combination thereof.

16. The composite of claim 1 wherein R′ or R″ comprise a functional group that comprises nitrogen, oxygen, sulfur, fluorine, or combination thereof.

17. The composite of claim 16 wherein the functional group is an amine group.

18. The composite of claim 1 wherein the alkoxosilane precursor comprises 3-aminopropyl trimethoxysilane, N-(2-aminoethyl) 3-aminopropyl trimethoxysilane, (3-trimethoxysilylpropyl) diethylenetriamine, Bis-[(trimethoxysilyl)-propyl]-ethylenediamine, or a combination thereof.

19. The composite of claim 16 wherein the functional group is a cyano-group.

20. The composite of claim 1 wherein the alkoxosilane precursor comprises 2-cyanoethyltriethoxysilane, bis(cyanopropyl)dichlorosilane, bis(3-cyanopropyl)dimethoxysilane, 2-cyanoethylmethyldichlorosilane, 2-cyanoethyltrichlorosilane, 2-cyanoethyltrimethoxysilane, 3-cyanopropylmethyldimethoxysilane, 3-cyanopropyltrimethoxysilane, 3-cyanopropyltriethoxysilane, 11-cyanoundecyltrimethoxysilane, poly(cyanopropylmethylsiloxane), or combinations thereof.

21. The composite of claim 16 wherein the functional group is a fluoro-group.

22. The composite of claim 21 wherein the alkoxosilane precursor comprises tridecafluoro-(1,1,2,2-tetrahydrooctyl)triethoxysilane, poly(3,3,3-trifluoropropylmethylsiloxane), (heptadecafluoro-1,1,2,2-tetrahydrodecyl)trichlorosilane, (heptadecafluoro-1,1,2,2-tetrahydrodecyl)methyldichlorosilane, (heptadecafluoro-1,1,2,2-tetrahydrodecyl)triethoxysilane, (heptadecafluoro-1,1,2,2-tetrahydrodecyl)trimethoxysilane, pentafluorophenyltriethoxysilane, 3,3,3-trifluoropropyl)trimethoxylsilane, combinations thereof.

23. The composite of claim 1 wherein the mixture comprises a multiplicity of alkoxosilane precursors.

24. The composite of claim 23 wherein the multiplicity of alkoxosilane precursors are ethyltrimethoxysilane and dimethyidimethoxysilane.

25. The composite of claim 1 wherein the ethyltrimethoxysilane and dimethyidimethoxysilane are at concentrations such that the molar ratio of ethyltrimethoxysilane to dimethyldimethoxysilane is between about 1:0.64 and about 1:10.

26. The composite of claim 1 wherein the molar ratio of ethyltrimethoxysilane ethyltrimethoxysilane to dimethyidimethoxysilane is between about 1:1 and about 1:6.

27. The composite of claim 1 wherein the coating comprises a multiplicity of layers and each layer is formed from the mixture.

28. The composite of claim 27 wherein the coating comprises an outermost layer that is formed from the mixture in which R′ is —CₙH₂ₙ₊₁, R″ is —(CₙH₂ₙ)—, and n is an integer from 6 to 18.

29. A composite having a surface that is at least hydrophobic, the composite comprising:
a. a substrate; and
b. a hydrophobic coating on at least a portion of the substrate, the hydrophobic coating being formed from a mixture comprising a sol-gel that comprises an alkoxosilane precursor having a general formula of R′₂Si(OR)₂, R′₃Si(OR)₃, or (RO)₃SiR″Si(OR)₃, wherein R is a short chain, branched or unbranched, organic group that comprises no more than 5 carbon atoms in the chain and are the same or different, and R′ and R″ are long chain, branched or unbranched, organic groups that comprise between 6 and 20 carbon atoms in the chain, and comprising a topography that decreases a contact area between the hydrophobic coating and a water droplet thereon.

30. A superhydrophobic surface, the superhydrophobic surface being formed from a mixture that comprises a sol-gel that comprises an alkoxosilane precursor having a general formula of R′ₓSi(OR)₄₋ₓ or (RO)₃SiR″Si(OR)₃, wherein R and R′ are the same or different and comprise hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2, and comprising a topography that decreases a contact area between the superhydrophobic surface and a water droplet thereon so that the water droplet has a contact angle of at least about 160°.

31. The superhydrophobic surface of claim 30 wherein the contact angle is at least about 165°.

32. The superhydrophobic surface of claim 30 wherein the contact angle is at least about 170°.

33. A method of forming a composite having a surface that is at least hydrophobic, the method comprising depositing a hydrophobic coating on at least a portion of a substrate, wherein the hydrophobic coating is formed from a mixture comprising a sol-gel that comprises an alkoxosilane precursor having a general formula of R′ₓSi(OR)₄₋ₓ or (RO)₃SiR″Si(OR)₃, wherein R and R′ are the same or different and comprise hydrogen, a substituted or unsubstituted alkyl, a substituted or unsubstituted alkenyl, a substituted or unsubstituted alkynyl, a substituted or unsubstituted or multiple ring aryl group, or a combination thereof, and R″ is a substituted or unsubstituted alkylene, a substituted or unsubstituted alkenylene, a substituted or unsubstituted alkynylene, a substituted or unsubstituted or multiple ring arylene group, or a combination thereof, and x is 1 or 2, and comprises a topography that decreases a contact area between the hydrophobic coating and a water droplet thereon.

34. The method claim 33 further comprising drying the deposited hydrophobic sol-gel coating for at least 24 hours.

35. The method of claim 33 wherein the hydrophobic coating further comprises hair-like surface features.

36. The method of claim 33 wherein the topography comprises features having a size that are between about 10 nanometers and about 5 millimeters that are formed by depositing the hydrophobic coating on the substrate, which has a substrate topography, by patterning the hydrophobic coating, by including particulate in the mixture, or by a combination thereof.

37. The method of claim 36 wherein the topography is formed by patterning the hydrophobic coating with a template that comprises features that are bumps, depressions, or a combination thereof having a size that is between about 10 nanometers and about 100 micrometers.

38. The method of claim 37 wherein the template comprises a surface that is an organic polymer that hydrogen bonds with the sol-gel.

39. The method of claim 38 wherein the organic polymer is polyester, polyamide, or a copolymer thereof.

40. The method of claim 37 wherein the template comprises a surface that is an organic polymer that does not hydrogen bond with the sol-gel.

41. The method of claim 40 wherein the organic polymer is polypropylene.

42. The method of claim 36 wherein the topography is formed by depositing the hydrophobic coating on the substrate, which has a substrate topography, wherein the substrate topography comprises features having a size that is between about 10 and about 100 micrometers.

43. The method of claim 36 wherein the topography is formed by including particulate in the mixture, wherein the particulate has a size that is between about 0.01 and about 50 μm and is at a concentration that is between about 0.01 and about 1 g of particulate per mL of sol-gel, and the mixture further comprises water at a volume ratio of sol-gel to water that is between about 25:10 and about 25:50.
